(19) United States
(12) Patent Application Publication
(10) Pub. No.: US 2025/0236481 A1
(43) Pub. Date: Jul. 24, 2025

(54) WINDING APPARATUS

(71) Applicant: CKD CORPORATION, Aichi (JP)

(72) Inventors: Yusuke Yamaguchi, Aichi (JP); Tsuyoshi Ohyama, Aichi (JP); Norihiko Sakaida, Aichi (JP)

(73) Assignee: CKD CORPORATION, Aichi (JP)

(21) Appl. No.: 19/008,877

(22) Filed: Jan. 3, 2025

(30) Foreign Application Priority Data
Jan. 24, 2024 (JP) 2024-008743

(51) Int. Cl. B65H 18/10; B65H 23/02; B65H 39/16; H01M 10/04

(52) U.S. Cl. CPC B65H 18/103; B65H 23/02; B65H 39/16; H01M 10/0409; B65H 2404/10; B65H 2404/69; B65H 2701/19

(57) ABSTRACT

A winding apparatus winds up a belt-shaped electrode sheet including an active material and a belt-shaped separator sheet made of an insulating material, and includes: a rotatable winding core to which the electrode and sheets are fed at accelerating or decelerating speed, and around which the electrode sheet and the separator sheet are wound; a rotatable transfer roller that defines a transfer path of the electrode sheet and has an outer circumference face on which the electrode sheet is placed; and a swing motion suppressing guide disposed at a position immediately upstream of the transfer roller along the transfer path. The electrode sheet includes: an electrode main body on which the active material is applied; and tabs protruded from a width direction edge portion of the electrode main body and disposed at intervals along a longitudinal direction of the electrode main body.

### BACKGROUND

### Technical Field

The present disclosure relates to a winding apparatus configured to provide, for example, a winding element that is built in a secondary battery or the like.

### Description of Related Art

For example, a winding element used for a secondary battery, such as a lithium-ion battery, is manufactured by winding a cathode sheet (positive electrode sheet) with a cathode active material (positive electrode active material) applied thereon and an anode sheet (negative electrode sheet) with an anode active material (negative electrode active material) applied thereon, which are overlaid one upon the other via a separator sheet made of an insulating material.

A known configuration of the electrode sheet includes an electrode main body with an active material applied on a surface thereof, and tabs protruded from a width direction edge portion of the electrode main body. The tabs are disposed at intervals along a longitudinal direction of the electrode main body.

A known configuration of a winding apparatus used to manufacture the winding element includes a rotatable winding core; and a feed mechanism configured to feed the electrode sheets and the separator sheet to the winding core. Such a winding apparatus is provided with a transfer roller that is freely rotatable and that causes an electrode sheet or the like to be placed thereon. The transfer roller serves to define or specify a transfer path of the electrode sheet or the like.

When the electrode sheet having the tabs passes through the transfer roller, the tabs are likely to be bent or broken. A technique of providing a deformation preventive member at a position of the transfer roller corresponding to an inlet of the electrode sheet has been proposed, with a view to dealing with the possibility that the tabs are bent or broken (as described in, for example, Patent Literature 1). The deformation preventive member is disposed in such a state as to be separated from an outer circumferential face on one end in a width direction of the transfer roller. The configuration of guiding the tabs between the deformation preventive member and the transfer roller aims to prevent the tabs from being bent or broken.

### PATENT LITERATURE

Patent Literature 1: Japanese Patent No. 2016-35892A

As a result of the intensive study by the inventors of the present application, it has been confirmed that a significant damage is likely to be given to the tabs because of the following reasons, when the tabs pass through the transfer roller.

In the process of winding the electrode sheet, the electrode sheet is not continuously transferred at a constant speed but is transferred at accelerating or decelerating speed. Such acceleration and deceleration of the electrode sheet cause vibration and resonance of the electrode sheet and thereby cause the tabs to have swing motion along a thickness direction of the electrode sheet. When the swing-moving tabs collide with an outer circumferential face of the transfer roller, a significant damage is given to the tabs.

The technique described in Patent Literature 1, however, does not prevent the tabs from colliding with the outer circumferential face of the transfer roller. Moreover, the swing-moving tabs are likely to collide with not only the outer circumferential face of the transfer roller but with the deformation preventive member. There is accordingly a possibility that the tabs are significantly damaged.

### SUMMARY

By taking into account the circumstances described above, one or more embodiments of the present disclosure provide a winding apparatus that effectively suppresses tabs of an electrode sheet from being significantly damaged when the tabs pass through a transfer roller.

The following describes each of various aspects of the present disclosure. Functions and advantageous effects that are characteristic of each of the aspects are also described as appropriate.

Aspect 1. There is provided a winding apparatus that winds up a belt-shaped electrode sheet including an active material and a belt-shaped separator sheet made of an insulating material. The winding apparatus comprises: a rotatable winding core to which the electrode sheet and the separator sheet are fed at accelerating or decelerating speed, and around which the electrode sheet and the separator sheet are wound; a rotatable transfer roller that defines a transfer path of the electrode sheet and has an outer circumference face on which the electrode sheet is placed; and a swing motion suppressing guide disposed at a position immediately upstream of the transfer roller along the transfer path. The electrode sheet comprises: an electrode main body on which the active material is applied; and tabs protruded from a width direction edge portion of the electrode main body and disposed at intervals along a longitudinal direction of the electrode main body. The swing motion suppressing guide is configured to contact the tabs and suppress a swing motion of the tabs while the electrode sheet is transferred from the upstream toward downstream of the transfer roller along the transfer path, wherein a contact location of the tabs that contacts the swing motion suppressing guide gradually changes from a base side of the tabs to a leading end side of the tabs while the tabs move from the upstream toward the downstream.

In the winding apparatus of this Aspect 1, the swing motion suppressing guide suppresses the swing motion of the tabs on the upstream of the transfer roller. This configuration more effectively prevents the swing-moving tabs from colliding with the outer circumferential face of the transfer roller.

In order to suppress the swing motion of the tabs, the swing motion suppressing guide is first brought into contact with the base side of the tabs, which has relatively small kinetic energy involved in the swing motion. The swing motion suppressing guide is subsequently brought into contact with the leading end side of the tabs, in the state that the contact with the base side suppresses the swing motion of the tabs to some extent and reduces the kinetic energy at the leading end side of the tabs to a certain extent. Accordingly, this configuration gradually suppresses the swing motion of the tabs, while comparatively reducing the load applied to the tabs at a time when the tabs come into contact with the swing motion suppressing guide.

As described above, the configuration of above Aspect 1 suppresses the swing motion of the tabs, so as to prevent the tabs from colliding with the transfer roller. Moreover, this configuration does not cause a significant load to be applied to the tabs in the process of suppressing the swing motion. Accordingly, this configuration effectively suppresses the tabs from being significantly damaged when the tabs pass through the transfer roller. As a result, this keeps the tabs in the good condition with less damage and thereby improves the quality of the winding element eventually obtained.

Aspect 2. In the winding apparatus described in above Aspect 1, the swing motion suppressing guide may be configured by a tapered guide plate that has a width direction edge portion disposed to overlap a transfer path of the tabs. The width direction edge portion of the tapered guide may be inclined such as to gradually displace from a position corresponding to the base side of the tabs to a position corresponding to the leading end side of the tabs from the upstream toward the downstream, when viewed from a direction perpendicular to the electrode main body. The width direction edge portion of the tapered guide may be configured to contact the tabs and suppress the swing motion of the tabs.

The configuration of this Aspect 2 enables the swing motion suppressing guide to have a relatively simple shape. This reduces the cost related to, for example, manufacture and maintenance of the swing motion suppressing guide.

Aspect 3. In the winding apparatus described in above Aspect 1, the swing motion suppressing guide may be configured by divisional guide portions disposed along the transfer path. The divisional guide portions may be configured such that width direction edge portions of divisional guide portions located on a downstream side along the transfer path are closer to the leading end side of the tabs, than are width direction edge portions of divisional guide portions located on an upstream side along the transfer path, when viewed from a direction perpendicular to the electrode main body. The width direction edge portions of the divisional guide portions may be configured to contact the tabs and suppress the swing motion of the tabs.

The configuration of this Aspect 3 enables the swing motion suppressing guide to have a relatively simple shape. This reduces the cost related to, for example, manufacture and maintenance of the swing motion suppressing guide.

Aspect 4. In the winding apparatus described in above Aspect 3, a location of each of the divisional guide portions may be adjustable along a width direction of the electrode sheet.

The configuration of this Aspect 4 enables the same swing motion suppressing guide to be used for a variety of electrode sheets having, for example, different shapes and different sizes by adjusting the locations of the respective divisional guide portions without requiring replacement of the swing motion suppressing guide. This enhances the convenience in relation to production of the winding element and reduces the cost related to, for example, manufacture of the apparatus.

Aspect 5. In the winding apparatus described in above Aspect 3, each of the divisional guide portions may be configured by a roller that is freely rotatable about a rotation axis parallel to a rotation axis of the transfer roller.

The configuration of this Aspect 5 more effectively reduces the load applied to the tabs when the tabs are brought into contact with the swing motion suppressing guide (the divisional guide portions). This furthermore effectively improves the quality of the obtained winding element.

Aspect 6. In the winding apparatus described in above Aspect 1, the swing motion suppressing guide may basically have a rectangular parallelopiped shape, and have an inclined surface formed by cutting off a part of the rectangular parallelopiped shape. The inclined surface passes through: an upstream side face located on an upstream side along the transfer path; a sheet side face adjacent to the upstream side face and facing the electrode sheet side; and a tab leading end side face adjacent to the upstream side face and the sheet side face. The inclined surface may be configured to contact the tabs and suppress the swing motion of the tabs.

In the winding apparatus of this Aspect 6, the swing motion suppressing guide has the basic form of rectangular parallelopiped and also has the inclined surface formed by cutting off such as to pass through the three faces that are adjacent to each other. This configuration enables the swing motion suppressing guide to have a relatively simple shape. This reduces the cost related to, for example, manufacture and maintenance of the swing motion suppressing guide.

Moreover, the inclined surface has such a shape that gradually approaches an ideal transfer path (with no swing motion) of the tabs from the upstream side toward the downstream side along the transfer direction of the electrode sheet. The tabs are thus gradually shifted to the ideal transfer path side, while the tabs move with being in contact with the inclined surface. Accordingly, this configuration more effectively suppresses the swing motion of the tabs.

Furthermore, this configuration enables the swing motion suppressing guide to have a relatively large thickness and thereby suppresses the vibration of the swing motion suppressing guide. This more certainly assures the effect of suppressing the swing motion of the tabs.

Aspect 7. In the winding apparatus described in above Aspect 1, a region of the swing motion suppressing guide corresponding to an inlet for the tabs may have an inclined surface or a curved surface that gradually approaches the transfer path from the upstream toward the downstream.

Even when the tabs come into contact with the region of the swing motion suppressing guide corresponding to the inlet for the tabs, the configuration of this Aspect 7 reduces the load applied to the tab to a relatively low level. This more certainly improves the quality of a winding element obtained.

Aspect 8. In the winding apparatus described in above Aspect 1, a region of the swing motion suppressing guide that contacts the tabs may have a curved surface without corners.

The configuration of this Aspect 8 more effectively reduces the load applied to the tabs accompanied with the contact with the swing motion suppressing guide. This furthermore certainly improves the quality of the winding element.

Aspect 9. The winding apparatus described in above Aspect 1 may comprise another swing motion suppressing guide, wherein one of the swing motion suppressing guides is disposed corresponding to a back side of a surface of the electrode sheet, the surface contacting an outer circumferential face of the transfer roller, and another of the swing motion suppressing guides is disposed corresponding to the surface of the electrode sheet, and is disposed at such a position that the tabs are placed between the swing motion suppressing guides.

The configuration of this Aspect 9 has the two swing motion suppressing guides disposed such as to place the tabs therebetween and thereby further enhances the effect of suppressing the swing motion of the tabs.

Aspect 10. In the winding apparatus described in above Aspect 1, the swing motion suppressing guide may be disposed corresponding to a back side of a surface of the electrode sheet, the surface contacting an outer circumferential face of the transfer roller. The winding apparatus of this aspect may further comprise a roller outer circumferential guide that is: disposed adjacent to the swing motion suppressing guide along the transfer path; disposed at such a position that the tabs are placed between the outer circumferential face of the transfer roller and the roller outer circumferential guide; and formed to have an inner arc surface that extends along a circumferential direction of the transfer roller when viewed from a direction of a rotation axis of the transfer roller.

A region of the electrode sheet that is placed on the transfer roller is deformed in an arch shape. The tabs may have a rise, accompanied with this deformation. Such a rise of the tabs may bring the tabs into contact with a peripheral device so as to give a damage to the tabs or may cause a poor weld in the process of welding a plurality of tabs with each other. As a result, this may lower the quality of a product (the quality of the winding element) and the productivity.

In the winding apparatus of above Aspect 10, however, the roller outer circumferential guide serves to more certainly prevent such a rise of the tabs. This further improves the quality of the product and enhances the productivity.

Furthermore, using the swing motion suppressing guide suppresses the swing motion of the tabs at the position upstream of the roller outer circumferential guide. This configuration more effectively prevents the swing-moving tabs from colliding with the roller outer circumferential guide. This means that the swing motion suppressing guide more effectively works in the configuration provided with the roller outer circumferential guide.

Aspect 11. In the winding apparatus described in above Aspect 10, the roller outer circumferential guide may be configured to satisfy an expression of 0.1≤R1−L1≤1.0,
where R1 millimeter (mm) denotes a radius of an inner surface of the roller outer circumferential guide about the rotation axis, and L1 millimeter (mm) denotes a distance from the rotation axis to a width-direction edge of a leading end of the tabs, when viewed from the direction of the rotation axis, in a state where the tabs are located between the roller outer circumferential guide and the transfer roller and the leading end is flat.

At least the leading end of the tabs may not be curved along the outer circumferential face of the transfer roller but may be kept in a flat state, when the tabs pass through the transfer roller.

By taking into account this possibility, in the winding apparatus of this Aspect 11, the roller outer circumferential guide is configured to satisfy an expression of 0.1≤R1−L1≤1.0. More specifically, in the state that it is assumed that the leading end of the tabs is not curved but is kept flat when the tabs pass through the transfer roller, the size of a gap formed between a location of the tabs that becomes closest to the inner surface of the roller outer circumferential guide (i.e., the width direction edge of the leading end of the tabs) and the inner surface of the roller outer circumferential guide is configured to be not less than 0.1 mm and not greater than 1.0 mm. Making the size of the gap to be not less than 0.1 mm suppresses the tabs from excessively coming into contact with the inner surface of the roller outer circumferential guide and thereby further reduces the load applied to the tabs. Making the size of the gap to be not greater than 1.0 mm, on the other hand, more certainly assures the effect of preventing the rise of the tabs by the presence of the roller outer circumferential guide.

The technical features relating to the respective aspects described above may be combined appropriately. For example, the technical features relating to Aspect 2 or Aspect 3 described above may be combined with the technical features relating to Aspect 7 or Aspect 8 described above. In another example, the technical features relating to Aspect 2, Aspect 3, or Aspect 6 described above may be combined with the technical features relating to Aspect 10 or Aspect 11 described above.

### BRIEF DESCRIPTION OF DRAWINGS

FIG. 1 is a schematic perspective view illustrating the schematic configuration of a battery element;

FIG. 2 is a schematic plan view illustrating the schematic configuration of a cathode sheet;

FIG. 3 is a schematic plan view illustrating the schematic configuration of an anode sheet;

FIG. 4 is a schematic configuration diagram illustrating a winding apparatus;

FIG. 5 is a schematic configuration diagram illustrating a winding unit;

FIG. 6 is a schematic perspective view illustrating a roller device and its periphery;

FIG. 7 is a schematic plan view illustrating the roller device and its periphery;

FIG. 8 is a partly enlarged sectional view taken on a line J-J in FIG. 7;

FIG. 9 is a partly enlarged sectional view taken on a line K-K in FIG. 7;

FIG. 10 is a partly enlarged sectional view illustrating the size of a gap formed between tabs and a roller outer circumferential guide;

FIG. 11 is a schematic front view illustrating a correction module;

FIG. 12 is a schematic configuration diagram illustrating the winding unit when separator sheets are placed in a clearance of a winding core;

FIG. 13 is a schematic configuration diagram illustrating the winding unit when the separator sheets are cut;

FIG. 14 is a schematic configuration diagram illustrating the winding unit at the time of termination of winding of the electrode sheets and the like;

FIG. 15 is a schematic perspective view illustrating a swing motion suppressing guide that is formed by bending part of a metal plate or a resin plate according to another example of the embodiments;

FIG. 16 is a partly broken schematic perspective view illustrating a swing motion suppressing guide according to another example of the embodiments,

FIG. 17 is a schematic perspective view illustrating divisional guide portions that configure a swing motion suppressing guide, and their periphery according to another example of the embodiments;

FIG. 18 is a partly enlarged schematic side view illustrating the divisional guide portions and their periphery according to another example of the embodiments;

FIG. 19 is a schematic plan view illustrating the divisional guide portions and their periphery according to another example of the embodiments;

FIG. 20 is a schematic perspective view illustrating divisional guide portions of a relatively short shape and their periphery according to another example of the embodiments;

FIG. 21 is a schematic perspective view illustrating divisional guide portions configured by rotatable rollers and their periphery according to another example of the embodiments;

FIG. 22 is a schematic perspective view illustrating a swing motion suppressing guide having an inclined surface and its periphery according to another example of the embodiments;

FIG. 23 is a schematic perspective view illustrating the swing motion suppressing guide and its periphery when viewed from an inclined surface side according to another example of the embodiments;

FIG. 24 is a schematic perspective view illustrating two swing motion suppressing guides placed at such a position that tabs are located therebetween and its periphery according to another example of the embodiments; and

FIG. 25 is a schematic side view illustrating the two swing motion suppressing guides placed at the that the tabs are located therebetween and its periphery according to another example of the embodiments.

### DETAILED DESCRIPTION OF EMBODIMENTS

The following describes embodiments with referring to the drawings. The configuration of a lithium-ion battery element that is a winding element obtained by a winding apparatus is described first.

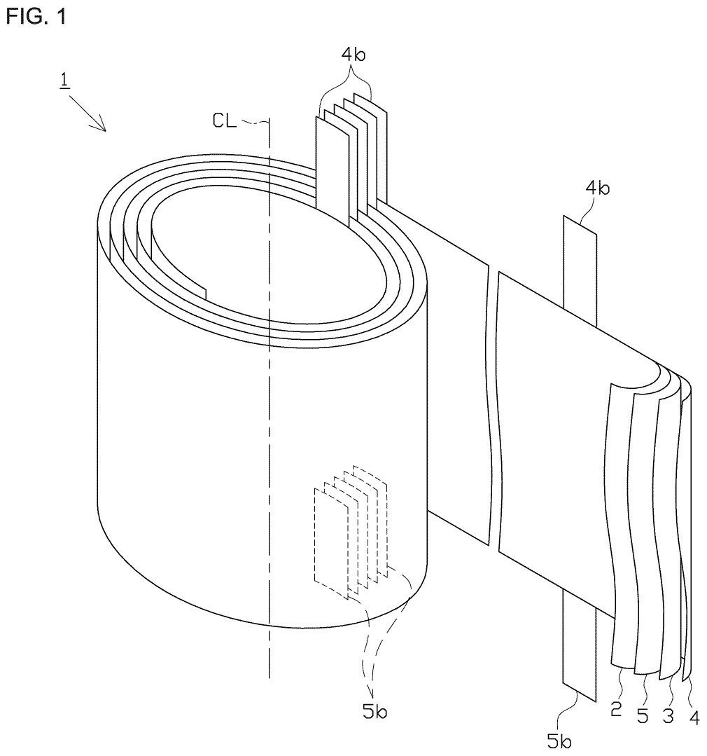

As shown in FIG. 1, a lithium-ion battery element 1 (hereinafter simply referred to as “battery element 1”) is manufactured by winding a cathode sheet (positive electrode sheet) 4 and an anode sheet (negative electrode sheet) 5 that are overlaid with each other via two separators 2 and 3. According to one or more embodiments, each of the cathode sheet 4 and the anode sheet 5 corresponds to the “electrode sheet”. One folded-back separator sheet may be used in place of the two separator sheets 2 and 3. In the description below, the separator sheets 2 and 3 and the electrode sheets 4 and 5 may be collectively referred to as “respective sheets 2 to 5” for convenience of explanation.

The separator sheets 2 and 3 are respectively formed in belt shapes having identical widths and are made of an insulating material, such as polypropylene (PP), in order to prevent the different electrode sheets 4 and 5 from coming into contact with each other and causing a short circuit.

The respective electrode sheets 4 and 5 are thin plate-like metal sheets. For example, an aluminum foil sheet is used for the cathode sheet 4, and for example, a copper foil sheet is used for the anode sheet 5. The respective electrode sheets 4 and 5 are formed to be relatively thin-walled (for example, the thickness of 5 to 50 μm or 10 to 30 μm).

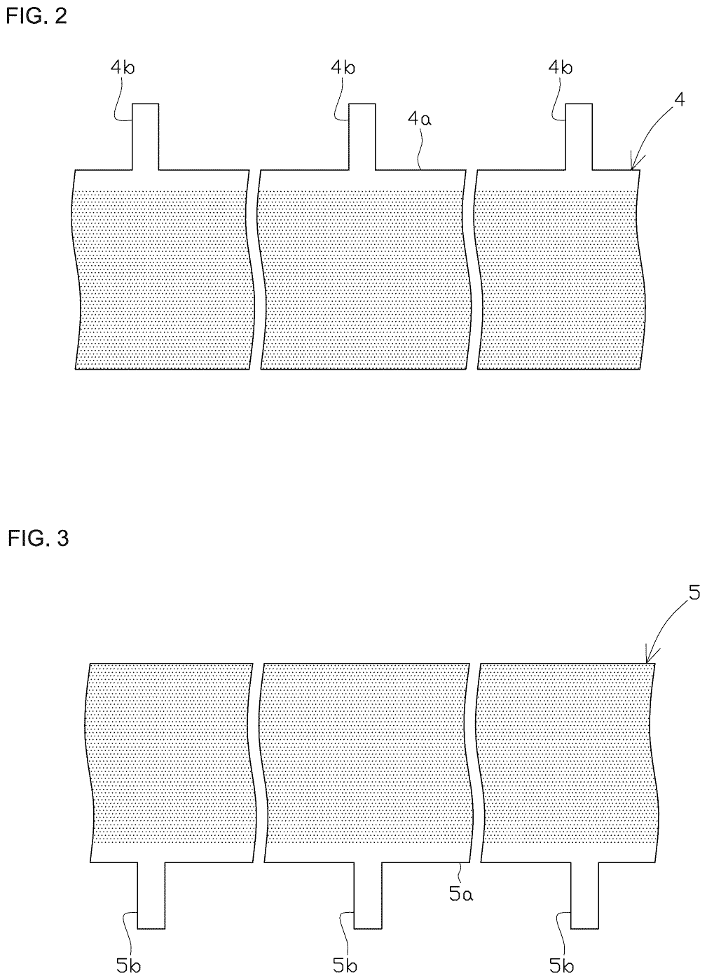

Additionally, as shown in FIG. 2 and FIG. 3, each of the electrode sheets 4 and 5 includes an electrode main body 4a or 5a and tabs 4b or 5b. Each of the electrode main bodies 4a and 5a has a width substantially equal to the widths of the separator sheets 2 and 3, and an active material is applied on both a surface and a rear face of each of the electrode main bodies 4a and 5a. For example, a cathode active material (positive electrode active material; for example, lithium manganate particles) is applied on the electrode main body 4a of the cathode sheet 4, and an anode active material (negative electrode active material; for example, active carbon) is applied on the electrode main body 5a of the anode sheet 5. In FIG. 2 and FIG. 3, areas where the active material is applied are shown by dotted patterns.

Such configuration allows for ion exchange between the cathode sheet 4 and the anode sheet 5 via the active materials. FIG. 2 and FIG. 3 illustrate the configurations that the active material is not applied in some parts of the electrode main body 4a or 5a (for example, edge portions in a width direction). In a modified configuration, however, the active material may be applied on the whole area of the electrode main body 4a or 5a.

The tabs 4b or 5b are so-called formed tabs that are formed by cutting parts of the electrode material and are integrated with the electrode main body 4a or 5a. A plurality of the tabs 4b or 5b are protruded from the edge portions in the width direction of the electrode main body 4a or 5a and are disposed at intervals along a longitudinal direction of the electrode main body 4a or 5a. In the configuration of one or more embodiments, the tabs 4b of the cathode sheet 4 are located on one end side of the battery element 1 along a direction of a center axis CL of the battery element 1, and the tabs 5b of the anode sheet 5 are located on the other end side of the battery element 1 along the direction of the center axis CL (as shown in FIG. 1). Accordingly, the respective tabs 4b and 5b are configured to be located on different end sides in the battery element 1. According to a modification, however, the respective tabs 4b and 5b may be configured to be located on an identical end side in the battery element 1.

A process of obtaining a lithium-ion battery places the battery element 1 in a non-illustrated battery container (case) that is made of a metal and that is in a cylindrical shape, and respectively bundles the tabs 4b together and the tabs 5b together. As occasion demands, the process respectively welds the bundled tabs 4b and the bundled tabs 5b. The process subsequently connects the bundled tabs 4b with a cathode terminal component (positive electrode terminal component; not shown), similarly connects the bundled tabs 5b with an anode terminal component (negative electrode terminal component; not shown), and provides the respective terminal components at such positions as to close respective end openings of the battery container, so as to obtain the lithium-ion battery.

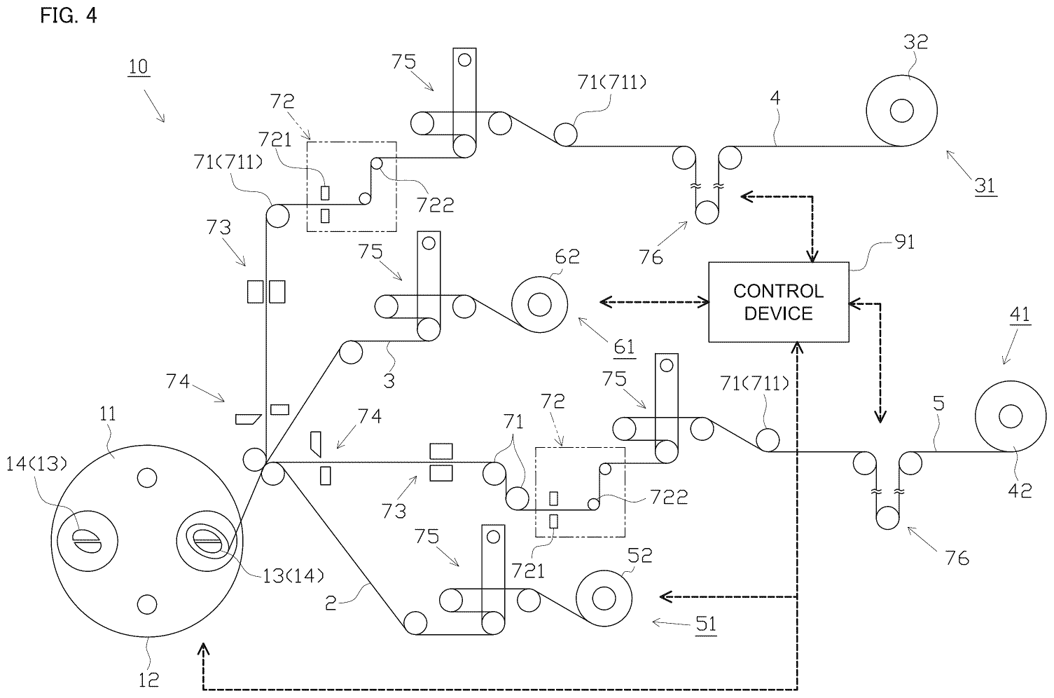

The following describes the winding apparatus 10 used to manufacture the battery element 1. As shown in FIG. 4, the winding apparatus 10 includes a winding unit 11 configured to wind the respective sheets 2 to 5; a cathode sheet feed mechanism (positive electrode sheet feed mechanism) 31 configured to feed the cathode sheet 4 to the winding unit 11; an anode sheet feed mechanism (negative electrode sheet feed mechanism) 41 configured to feed the anode sheet 5 to the winding unit 11; separator feed mechanisms 51 and 61 respectively configured to feed the separator sheet 2 and the separator sheet 3 to the winding unit 11; and a control device 91. The operations of the various mechanisms, such as the winding unit 11 and the respective feed mechanisms 31, 41, 51 and 61 in the winding apparatus 10 are controlled by the control device 91.

The cathode sheet feed mechanism 31 includes a cathode sheet roll 32 that is obtained by winding the cathode sheet 4 in a roll form. The cathode sheet roll 32 is supported in a freely rotatable manner, and the cathode sheet 4 is appropriately pulled out from this cathode sheet roll 32.

The cathode sheet feed mechanism 31 includes roller devices 71, a positional relationship maintaining mechanism 72, a sheet insertion mechanism 73, a sheet cutting cutter 74, a tension applying mechanism 75 and a buffer mechanism 76.

The roller device 71 is a device including, for example, a transfer roller 711 that is provided with the cathode sheet 4 placed on an outer circumferential face thereof and that is configured to define or specify a transfer path of the cathode sheet 4. A plurality of the roller devices 71 (a plurality of the transfer rollers 711) are disposed along the transfer path of the cathode sheet 4. The configuration of the roller device 71 will be described later in more detail.

The positional relationship maintaining mechanism 72 is disposed at a location immediately upstream of the transfer roller 711 along the transfer path of the cathode sheet 4 and is configured to maintain the positional relationship between a swing motion suppressing guide 717 and the like of the roller device 71 described later and the cathode sheet 4 placed on the transfer roller 711, in an appropriate state. The configuration of the positional relationship maintaining mechanism 72 will be also described later.

The sheet insertion mechanism 73 is configured to feed the cathode sheet 4 to the winding unit 11, while holding the cathode sheet 4.

The sheet cutting cutter 71 is configured to cut the cathode sheet 4. The cathode sheet 4 is cut in the state that the cathode sheet 4 is held by the sheet insertion mechanism 73. The sheet cutting cutter 74 is separable from the transfer path of the cathode sheet 4, so as not to interfere with feeding of the cathode sheet 4 by the sheet insertion mechanism 73.

The tension applying mechanism 75 is configured to apply a tensile force to the cathode sheet 4 and is provided with a plurality of rollers (for example, dancer rollers or the like). Controlling the operations of these rollers by the control device 91 enables the tensile force applied to the cathode sheet 4 by the tension applying mechanism 75 to be regulated. According to one or more embodiments, the tension applying mechanism 75 is configured to continuously apply a constant tensile force to the cathode sheet 4. The rollers included in the tension applying mechanism 75 may have a similar or identical configuration to that of the transfer roller 711. Accordingly, the swing motion suppressing guide 717 and the like described later may be applied to, for example, the rollers included in the tension applying mechanism 75.

The buffer mechanism 76 includes, for example, a pair of driven rollers and a lifting roller that is disposed between the two driven rollers to be displaceable in a vertical direction, and is configured to temporarily retain the cathode sheet 4. The rollers included in the buffer mechanism 76 may also have a similar or identical configuration to that of the transfer roller 711.

The anode sheet feed mechanism 41 includes an anode sheet roll 42 that is obtained by winding the anode sheet 5 in a roll form and that is located on a most upstream side thereof. The anode sheet roll 42 is supported in a freely rotatable manner, and the anode sheet 5 is appropriately pulled out from this anode sheet roll 42.

Roller devices 71, a positional relationship maintaining mechanism 72, a sheet insertion mechanism 73, a sheet cutting cutter 74, a tension applying mechanism 75, a buffer mechanism 76 and the like are disposed in the middle of a transfer path of the anode sheet 5 from the anode sheet roll 42 to the winding unit 11, as in the transfer path of the cathode sheet 4. These components are similar to those disposed in the transfer path of the cathode sheet 4, except that these components function with regard to the anode sheet 5.

The separator feed mechanism 51 and the separator feed mechanism 61, on the other hand, respectively include a separator roll 52 and a separator roll 62 that are respectively obtained by winding the separator sheet 2 and the separator sheet 3 in roll forms. The separator rolls 52 and 62 are respectively supported in a freely rotatable manner, and the separator sheets 2 and 3 are appropriately pulled out from the respective separator rolls 52 and 62.

Like the electrode sheet feed mechanisms 31 and 41, each of the separator feed mechanisms 51 and 61 is further provided with a tension applying mechanism 75. These tension applying mechanisms 75 are similar to the tension applying mechanism 75 disposed in the cathode sheet feed mechanism 31, except that these mechanisms 75 function with regard to the separator sheets 2 and 3.

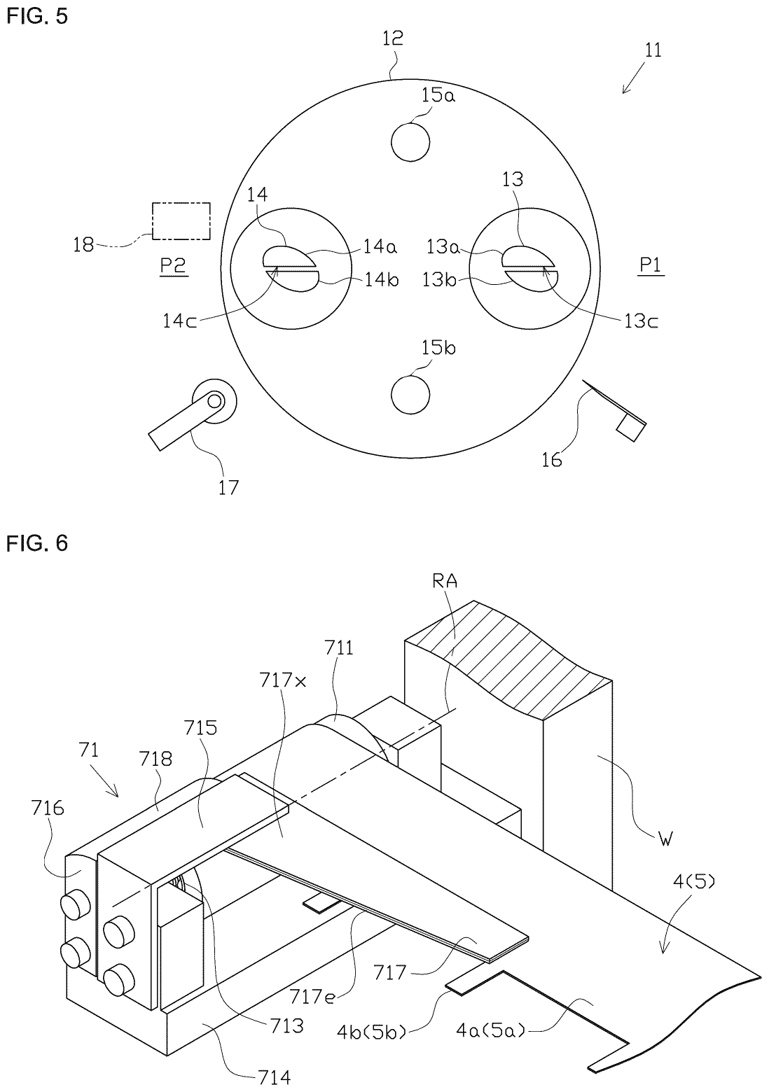

The following describes the configuration of the winding unit 11. As shown in FIG. 5, the winding unit 11 includes a turret 12 comprised of two disk-shaped tables that are opposed to each other and that are configured to be rotatable by a non-illustrated driving mechanism; two winding cores 13 and 14 disposed at an interval of 180 degrees in a rotating direction of the turret 12; two support rollers 15a and 15b disposed at positions shifted by approximately 90 degrees from the respective winding cores 13 and 14 in the rotating direction of the turret 12; a separator cutter 16; a pressing roller 17 configured to press the respective sheets 2 to 5 immediately before termination of winding; and a tape attaching mechanism 18 configured to attach a predetermined fixation tape. The winding unit 11 is further provided with, for example, a demounting device (not shown) that is configured to demount the battery element 1 from the winding core 13 or 14 and that is located in a periphery of a demounting position P2 described later.

Each of the winding cores 13 and 14 is used to wind up the respective sheets 2 to 5 on an outer circumferential face thereof and is configured to be rotatable about a center axis thereof as a rotation axis by a non-illustrated driving mechanism. The amount of rotation of each of the winding cores 13 and 14 is detectable by a non-illustrated encoder, and information with regard to the amount of rotation is input from the encoder into the control device 91.

Each of the winding cores 13 and 14 is disposed to be protruded and retreated relative to one of the tables configuring the turret 12 along an axial direction of the turret 12 (a depth direction of the sheet surface of FIG. 5). When each of the winding cores 13 and 14 is protruded from one of the tables, a leading end of the winding core 13 or 14 is inserted into a receiving hole formed in the other table, and the winding core 13 or 14 is supported in a rotatable state by both the tables.

Additionally, each of the winding cores 13 and 14 is configured to be in a non-circular shape in a cross section perpendicular to the rotation axis thereof. According to one or more embodiments, each of the winding cores 13 and 14 is in an elliptical shape in the cross section perpendicular to the rotation axis thereof. Since each of the winding cores 13 and 14 is in the non-circular shape in the cross section, even when the winding core 13 or 14 is rotated at a constant speed, the respective sheets 2 to 5 are fed to the winding core 13 or 14 at accelerating or decelerating speed. Immediately after a start of winding of the respective sheets 2 to 5, the respective sheets 2 to 5 are fed to the winding core 13 or 14 at accelerating speed. Immediately before termination of winding of the respective sheets 2 to 5, the respective sheets 2 to 5 are fed to the winding core 13 or 14 at decelerating speed.

Furthermore, each winding core 13 (14) includes a pair of core pieces 13a and 13b (14a and 14b) extended along the direction of the rotation axis thereof (the depth direction of the sheet surface of FIG. 5). A clearance 13c (14c) is formed between the core pieces 13a and 13b (14a and 14b). A chuck mechanism (not shown) configured to clamp the separator sheets 2 and 3 placed in the clearance 13c (14c) is disposed at a location where the clearance 13c (14c) of the winding core 13 (14) is formed.

Moreover, each of the winding cores 13 and 14 is configured to be turnable and movable between a winding position P1 and a demounting position P2 with the rotation of the turret 12. The winding position P1 denotes a position where the winding core 13 or 14 is located at the time of winding up the respective sheets 2 to 5. The demounting position P2 denotes a position where the winding core 13 or 14 is located at the time of demounting the respective sheets 2 to 5 (i.e., the battery element 1) after winding.

Each of the support rollers 15a and 15b is configured to catch and support the respective sheets 2 to 5 between the winding core 13 or 14, which is moved to the demounting position P2, and the feed mechanisms 31, 41, 51 and 61 described above.

The separator cutter 16 is configured to cut the separator sheets 2 and 3. The pressing roller 17 is configured to press the wound-up respective sheets 2 to 5.

The tape attaching mechanism 18 is configured to attach the fixation tape to respective terminal ends of the separator sheets 2 and 3 after completion of winding of the respective sheets 2 to 5.

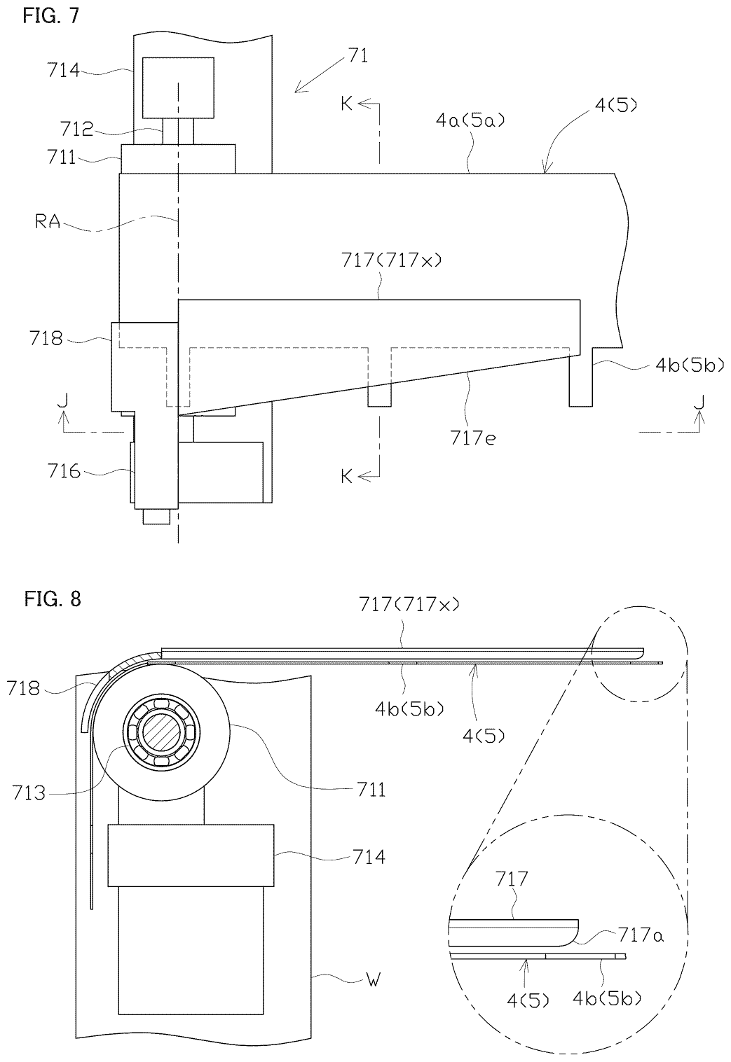

The following describes the roller device 71. As shown in FIG. 6 and FIG. 7, the roller device 71 includes a transfer roller 711, a shaft rod 712, bearings 713, a holder 714, an upstream-side guide support portion 715, a downstream-side guide support portion 716, a swing motion suppressing guide 717, and a roller outer circumferential guide 718.

As described above, the transfer roller 711 has the electrode sheet 4 or 5 placed on an outer circumferential face thereof and serves to define or specify the transfer path of the electrode sheet 4 or 5. The transfer roller 711 is in a cylindrical shape and is configured to be freely rotatable about a rotation axis RA. According to one or more embodiments, the transfer roller 711 has a width greater than the widths of the electrode sheets 4 and 5, so that the entirety in the width direction of the electrode sheet 4 or 5 including the tabs 4b or 5b can be placed on the outer circumferential face of the transfer roller 711.

The shaft rod 712 extends in a direction of the rotation axis RA and has respective ends thereof supported by the holder 714. According to one or more embodiments, the shaft rod 712 is fixed by the holder 714 and is configured to be not rotatable about the rotation axis RA. According to a modification, however, the shaft rod 712 may be configured to be rotatable about the rotation axis RA relative to the holder 714.

The bearing 713 is disposed between the shaft rod 712 and the transfer roller 711 and is configured to support the transfer roller 711 in a freely rotatable manner relative to the shaft rod 712. One bearing 713 is attached to each of the respective ends of the transfer roller 711 in the direction of the rotation axis RA in the state that center axes of the respective bearings 713 are coincident with the rotation axis RA.

The holder 714 serves to support the transfer roller 711 via the shaft rod 712 and the like and also serves to support the upstream-side guide support portion 715 and the downstream-side guide support portion 716. According to one or more embodiments, the holder 714 is fixed to a predetermined mounting element W to be not movable.

The upstream-side guide support portion 715 serves to support especially the swing motion suppressing guide 717 located on an upstream side in the transfer direction of the electrode sheet 4 or 5, out of the two guides 717 and 718. The upstream-side guide support portion 715 is configured not to come into contact with the tabs 4b or 5b even when the swing motion of the tabs 4b or 5b occurs.

The downstream-side guide support portion 716 serves to support especially the roller outer circumferential guide 718 located on a downstream side in the transfer direction of the electrode sheet 4 or 5, out of the two guides 717 and 718. According to one or more embodiments, the downstream-side guide support portion 716 is integrated with the roller outer circumferential guide 718. According to a modification, however, the downstream-side guide support portion 716 and the roller outer circumferential guide 718 may be provided as separate bodies. According to another modification, one integral guide support portion as an integration of the two guide support portions 715 and 716 may be configured to support both the swing motion suppressing guide 717 and the roller outer circumferential guide 718.

The swing motion suppressing guide 717 is disposed at a location immediately upstream of the transfer roller 711 along the transfer direction of the electrode sheet 4 or 5 and serves to, when the swing motion of the tabs 4b or 5b occurs, suppress the swing motion. The swing motion suppressing guide 717 is disposed along the transfer path of the electrode sheet 4 or 5. According to one or more embodiments, the swing motion suppressing guide 717 is disposed corresponding to a back side of a surface of the electrode sheet 4 or 5 that is placed on the outer circumferential face of the transfer roller 711. Furthermore, according to one or more embodiments, the swing motion suppressing guide 717 is configured by a tapered guide plate 717x, which has a width direction edge portion 717e that is inclined to the transfer direction of the electrode sheet 4 or 5 and which is gradually widened from the upstream side toward the downstream side along the transfer direction.

The width direction edge portion 717e of the swing motion suppressing guide 717 (the tapered guide plate 717x), which is located on the tabs 4b- or 5b-side, is close to an ideal transfer path (with no swing motion) of the tabs 4b or 5b and is allowed to come into contact with the tabs 4b or 5b in the case where the swing motion of the tabs 4b or 5b occurs. A region of the width direction edge portion 717e located on the upstream side in the transfer direction of the electrode sheet 4 or 5 is a location corresponding to a base side of the tabs 4b or 5b and overlaps with the base side of the tabs 4b or 5b when viewed from a direction perpendicular to the electrode main body 4a or 5a (i.e., along a thickness direction of the electrode main body 4a or 5a). A region of the width direction edge portion 717e located on the downstream side in the transfer direction of the electrode sheet 4 or 5 is, on the other hand, a location corresponding to a leading end side of the tabs 4b or 5b and overlaps with the leading end side of the tabs 4b or 5b when viewed from the direction perpendicular to the electrode main body 4a or 5a. The width direction edge portion 717e is inclined to be gradually displaced from a position corresponding to the base side of the tabs 4b or 5b to a position corresponding to the leading end side of the tabs 4b or 5b, from the upstream side toward the downstream side along the transfer direction of the electrode sheet 4 or 5, when viewed from the direction perpendicular to the electrode main body 4a or 5a.

The configuration described above causes a contact location of the swing-moving tabs 4b or 5b that is in contact with the swing motion suppressing guide 717 to gradually change from the base side of the tabs 4b or 5b to the leading end side of the tabs 4b or 5b, while the tabs 4b or 5b move from the upstream side toward the downstream side along the transfer direction of the electrode sheet 4 or 5. The configuration of providing such a swing motion suppressing guide 717 gradually suppresses the swing motion of the tabs 4b or 5b when the swing motion of the tabs 4b or 5b occurs.

Moreover, as shown in FIG. 8, an inlet portion 717a that is a region of the swing motion suppressing guide 717 corresponding to an inlet for the electrode sheet 4 or 5 has such a shape that gradually approaches the transfer path of the electrode sheet 4 or 5 from the upstream side toward the downstream side along the transfer direction of the electrode sheet 4 or 5. According to one or more embodiments, the inlet portion 717a has a curved surface that is convex to the electrode sheet 4- or 5-side (as shown in FIG. 8). According to a modification, however, the inlet portion 717a may have an inclined surface.

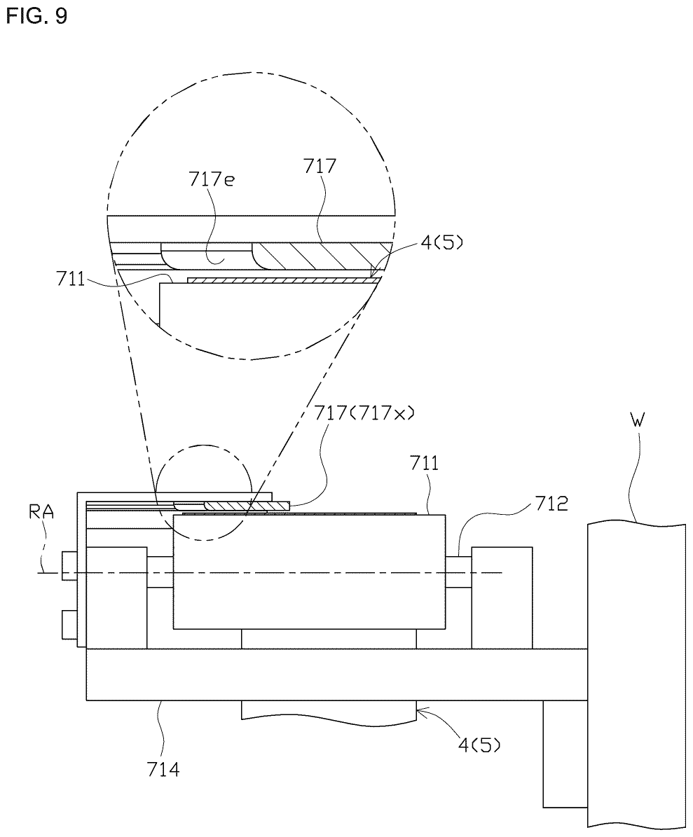

Furthermore, as shown in FIG. 9, a contact region (the width direction edge portion 717e) of the swing motion suppressing guide 717 that is configured to come into contact with the tabs 4b or 5b has a curved surface without corners (without edges). According to one or more embodiments, the curvature radius of the inlet portion 717a or of the width direction edge portion 717e is made smaller than the width of the tabs 4b or 5b along the transfer direction of the electrode sheet 4 or 5.

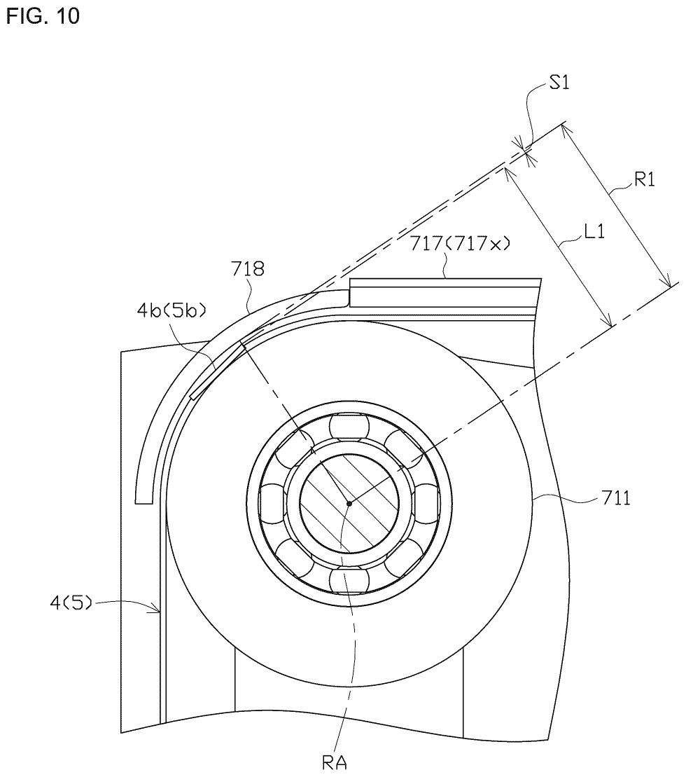

The roller outer circumferential guide 718 is a device serving to prevent the tabs 4b or 5b from rising to be separated from the transfer roller 711-side, when the tabs 4b or 5b are located on the outer circumference of the transfer roller 711. As shown in FIG. 10, the roller outer circumferential guide 718 is placed adjacent to the swing motion suppressing guide 717 along the transfer path of the electrode sheet 4 or 5 and is disposed at such a position that the tabs 4b or 5b are placed between the outer circumferential face of the transfer roller 711 and the roller outer circumferential guide 718. The roller outer circumferential guide 718 is formed as a curved plate and has an inner surface that is in an arc shape extended along a circumferential direction of the transfer roller 711 when viewed from the direction of the rotation axis RA of the transfer roller 711.

The leading end side of the tabs 4b or 5b may not be curved along the outer circumferential face of the transfer roller 711 but may be kept in a flat state, when the leading end side of the tabs 4b or 5b passes through the outer circumference of the transfer roller 711. By taking into account this possibility, the roller outer circumferential guide 718 is configured to satisfy an expression of 0.1≤R1−L1≤1.0.

In this expression, R1 (mm) denotes a radius of the inner surface of the roller outer circumferential guide 718 about the rotation axis RA of the transfer roller 711. L1 (mm) denotes a distance from the rotation axis RA of the transfer roller 711 to a width-direction edge of the leading end of the tabs 4b or 5b when viewed from the direction of the rotation axis RA, in such a state that the tabs 4b or 5b are located between the roller outer circumferential guide 718 and the transfer roller 711 and that it is assumed that the leading end of the tabs 4b or 5b is not curved but is kept flat.

Accordingly, the difference R1−L1 is equivalent to a size S1 of a gap formed between the inner surface of the roller outer circumferential guide 718 and the tabs 4b or 5b. The size S1 of this gap is not less than 0.1 mm and not greater than 1.0 mm.

The following describes the positional relationship maintaining mechanism 72. The positional relationship maintaining mechanism 72 serves to maintain the positional relationship between the swing motion suppressing guide 717 and the like and the electrode sheet 4 or 5 placed on the transfer roller 711, in an appropriate state as described above. The configuration of one or more embodiments is provided with a positional relationship maintaining mechanism 72 corresponding to one of the transfer rollers 711 included in the cathode sheet feed mechanism 31 and with a positional relationship maintaining mechanism 72 corresponding to one of the transfer rollers 711 included in the anode sheet feed mechanism 41. A plurality of the positional relationship maintaining mechanisms 72 may be disposed along the transfer path of each of the electrode sheets 4 and 5. For example, the positional relationship maintaining mechanism 72 may be disposed corresponding to each of the transfer rollers 711.

As shown in FIG. 4, the positional relationship maintaining mechanism 72 includes a position detector 721 configured to detect the position of the electrode sheet 4 or 5 in the width direction; a correction module 722 configured to correct a positional misalignment of the electrode sheet 4 or 5 in the width direction, based on the position detected by the position detector 721; and a correction actuator for meandering correction (not shown) configured to actuate the correction module 722.

The position detector 721 is configured by, for example, an edge sensor that is capable of detecting the position of the electrode sheet 4 or 5 in the width direction. Information with regard to the position of the electrode sheet 4 or 5 in the width direction detected by the position detector 721 is output to the control device 91.

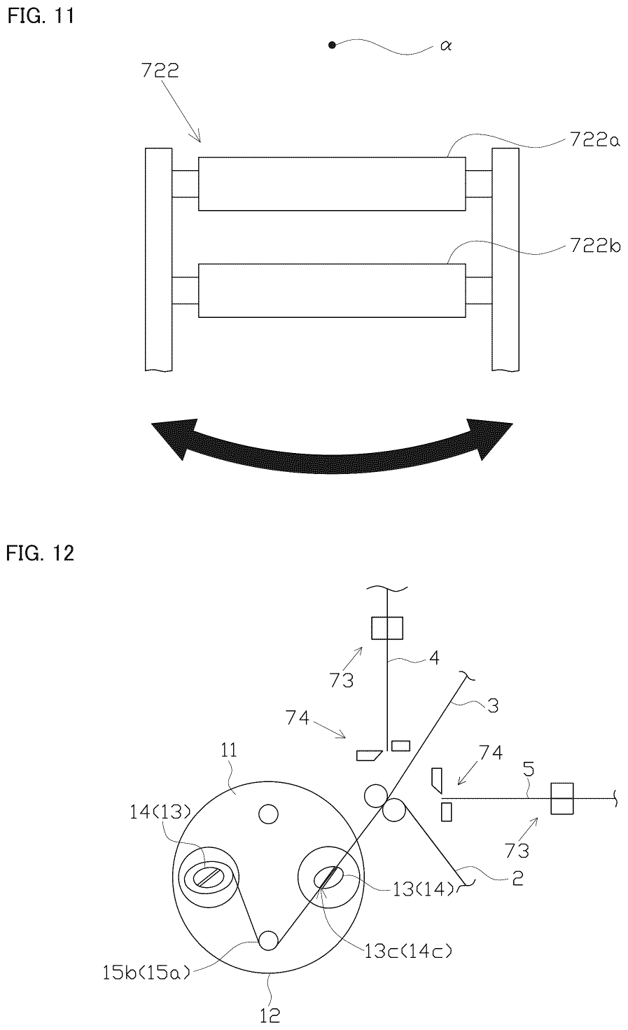

As shown in FIG. 11, the correction module 722 includes a pair of upper and lower rollers 722a and 722b and is configured to be pivotally rotatable about a pivot center a at the center above the upper roller 722a, which is the center of pivotal rotation, by the correction actuator. The control device 91 controls the correction actuator to pivotally rotate the correction module 722 and thereby correct the positional misalignment of the electrode sheet 4 or 5. This more effectively prevents a variation in positional relationship of the electrode sheet 4 or 5 (especially the tabs 4b or 5b) relative to the swing motion suppressing guide 717 and the roller outer circumferential guide 718.

The winding apparatus 10 configured as described above performs winding of the respective sheets 2 to 5 by a procedure described below. The procedure causes one winding core 13 (14) placed at the winding position P1 to be protruded from one of the tables of the turret 12 in the state that the separator sheets 2 and 3 are placed on the support roller 15a (15b) and the like, so as to place the separator sheets 2 and 3 in the clearance 13c (14c) of the winding core 13 (14) (as shown in FIG. 12). The procedure subsequently clamps the separator sheets 2 and 3 placed in the clearance 13c (14c) by the chuck mechanism described above. The procedure then rotates the one winding core 13 (14) by a predetermined number of times, so as to wind up the separator sheets 2 and 3 on the winding core 13 (14) by a predetermined amount.

The procedure then successively feeds the electrode sheets 4 and 5 to the one winding core 13 (14) by the respective sheet insertion mechanisms 73. The procedure subsequently rotates the winding core 13 (14) with feeding the respective sheets 2 to 5 to the winding core 13 (14), so as to overlay and wind the respective sheets 2 to 5 one upon another.

Immediately after a start of winding of the respective sheets 2 to 5, the respective sheets 2 to 5 are fed to the winding core 13 or 14 at accelerating speed. After a certain time period has elapsed since the start of winding of the respective sheets 2 to 5, the winding core 13 or 14 is rotated at a constant speed, so that the respective sheets 2 to 5 are fed to the winding core 13 or 14 at accelerating or decelerating speed. The swing motion of the tabs 4b or 5b may occur, accompanied with acceleration and deceleration of the electrode sheet 4 or 5. The swing motion suppressing guide 717, however, suppresses such swing motion.

The procedure temporarily stops the rotation of the one winding core 13 (14) at the stage when the respective sheets 2 to 5 are wound up by a predetermined length. At the time when the respective sheets 2 to 5 are temporarily stopped, the respective sheets 2 to 5 are fed to the winding core 13 or 14 at decelerating speed. During the temporary stop of the respective sheets 2 to 5, the electrode sheets 4 and 5 are cut by the respective sheet cutting cutters 74.

The procedure subsequently moves the one winding core 13 (14) with the respective sheets 2 to 5 wound thereon to the demounting position P2 by rotating the turret 12. This causes the separator sheets 2 and 3 to be spanned over the support roller 15a (15b) and the like. Rotating the turret 12 also moves the other winding core 14 (13) to the winding position P1. A subsequent winding operation of the respective sheets 2 to 5 is performed on this other winding core 14 (13).

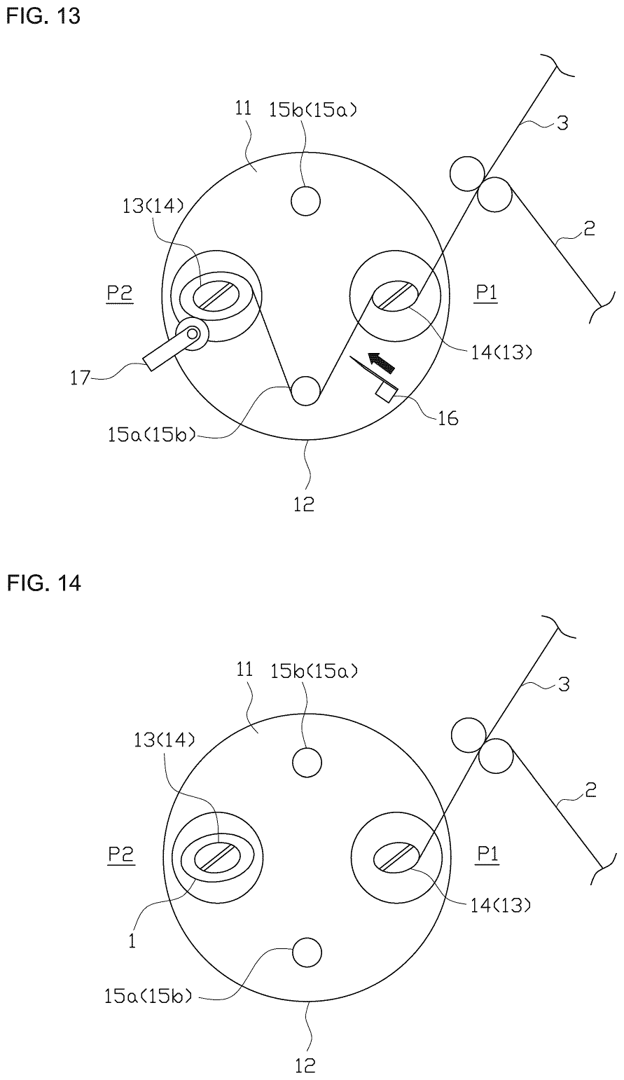

The procedure subsequently brings the pressing roller 17 close to the one winding core 13 (14) placed at the demounting position P2, causes the respective sheets 2 to 5 to be pressed by the pressing roller 17, and then cuts the separator sheets 2 and 3 by means of the separator cutter 16 (as shown in FIG. 13). The procedure subsequently rotates the one winding core 13 (14) to fully wind up the respective sheets 2 to 5 and attaches the fixation tape to the respective terminal ends of the separator sheets 2 and 3 by the tape attaching mechanism 18. This obtain the battery element 1 with the winding end treatment (as shown in FIG. 14). The obtained battery element 1 is demounted from the winding core 13 (14) by the demounting device described above.

As described above in detail, according to one or more embodiments, the swing motion suppressing guide 717 suppresses the swing motion of the tabs 4b or 5b on the upstream side of the transfer roller 711. This configuration more effectively prevents the swing-moving tabs 4b or 5b from colliding with the outer circumferential face of the transfer roller 711.

In order to suppress the swing motion of the tabs 4b or 5b, the swing motion suppressing guide 717 is first brought into contact with the base side of the tabs 4b or 5b, which has relatively small kinetic energy involved in the swing motion. The swing motion suppressing guide 717 is subsequently brought into contact with the leading end side of the tabs 4b or 5b, in the state that the contact with the base side suppresses the swing motion of the tabs 4b or 5b to some extent and reduces the kinetic energy at the leading end side of the tabs 4b or 5b to a certain extent. Accordingly, this configuration gradually suppresses the swing motion of the tabs 4b or 5b, while comparatively reducing the load applied to the tabs 4b or 5b at a time when the tabs 4b or 5b come into contact with the swing motion suppressing guide 717.

As described above, the configuration of one or more embodiments suppresses the swing motion of the tabs 4b or 5b, so as to prevent the tabs 4b or 5b from colliding with the transfer roller 711. Moreover, this configuration does not cause a significant load to be applied to the tabs 4b or 5b in the process of suppressing the swing motion. Accordingly, this configuration effectively suppresses the tabs 4b or 5b from being significantly damaged when the tabs 4b or 5b pass through the transfer roller 711. As a result, this keeps the tabs 4b or 5b in the good condition with less damage and thereby improves the quality of the battery element 1 eventually obtained.

Furthermore, the configuration of the swing motion suppressing guide 717 by the tapered guide 7171x enables the swing motion suppressing guide 717 to have a relatively simple shape. This reduces the cost related to, for example, manufacture and maintenance of the swing motion suppressing guide 717.

Moreover, the inlet portion 717a has such a shape that gradually approaches the transfer path of the electrode sheet 4 or 5 from the upstream side toward the downstream side along the transfer direction of the electrode sheet 4 or 5. Even when the tabs 4b or 5b come into contact with the inlet portion 717a, this configuration reduces the load applied to the tab 4b or 5b to a relatively low level. This more certainly improves the quality of the battery element 1.

Additionally, the contact region (the width direction edge portion 717e) of the swing motion suppressing guide 717 that is configured to come into contact with the tabs 4b or 5b has a curved surface without corners. This configuration more effectively reduces the load applied to the tabs 4b or 5b accompanied with the contact with the swing motion suppressing guide 717. This furthermore certainly improves the quality of the battery element 1.

The roller outer circumferential guide 718 more effectively prevents a rise of the tabs 4b or 5b. This further improves the quality of the battery element 1 and enhances the productivity.

Furthermore, using the swing motion suppressing guide 717 suppresses the swing motion of the tabs 4b or 5b at the position upstream of the roller outer circumferential guide 718. This configuration more effectively prevents the swing-moving tabs 4b or 5b from colliding with the roller outer circumferential guide 718. This means that the swing motion suppressing guide 717 more effectively works in the configuration provided with the roller outer circumferential guide 718.

Additionally, setting the size S1 of the gap to be not less than 0.1 mm suppresses the tabs 4b or 5b from excessively coming into contact with the inner surface of the roller outer circumferential guide 718 and furthermore reduces the load applied to the tabs 4b or 5b. Setting the size S1 of the gap to be not greater than 1.0 mm, on the other hand, more certainly assures the effect of preventing the rise of the tabs 4b or 5b by the presence of the roller outer circumferential guide 718.

The present disclosure is not limited to the description of the above embodiments but may be implemented, for example, by configurations described below. The present disclosure may also be naturally implemented by applications and modifications other than those illustrated below.

(a) The configuration of the swing motion suppressing guide is not limited to the configuration described in the above embodiments but may be changed or altered appropriately.

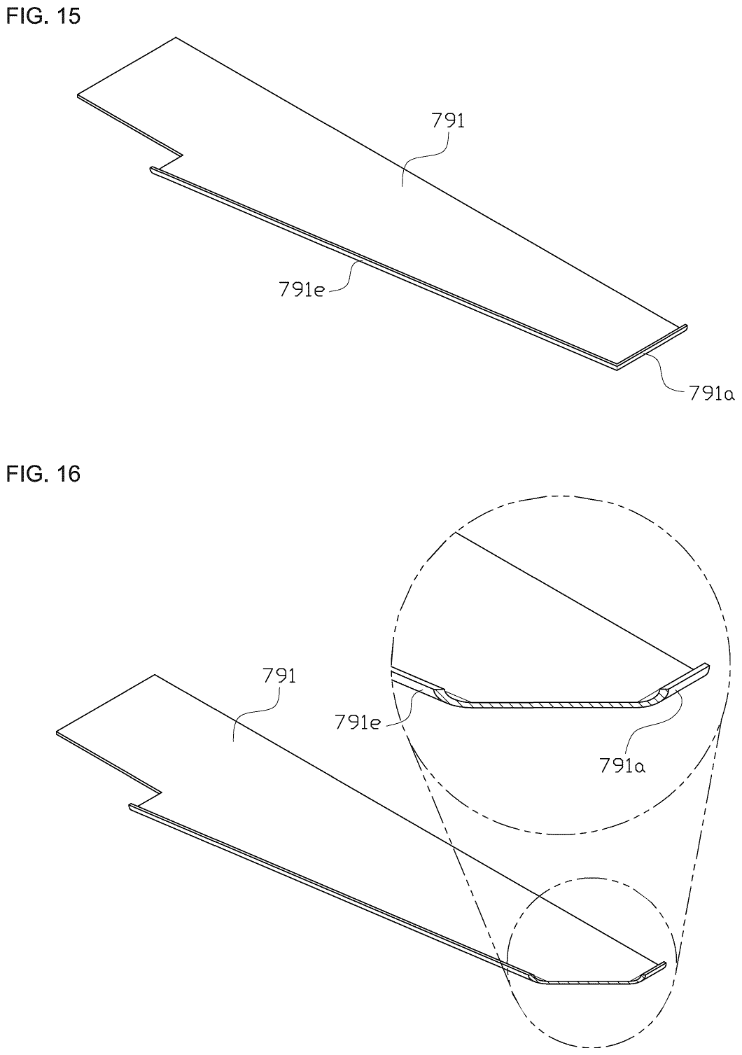

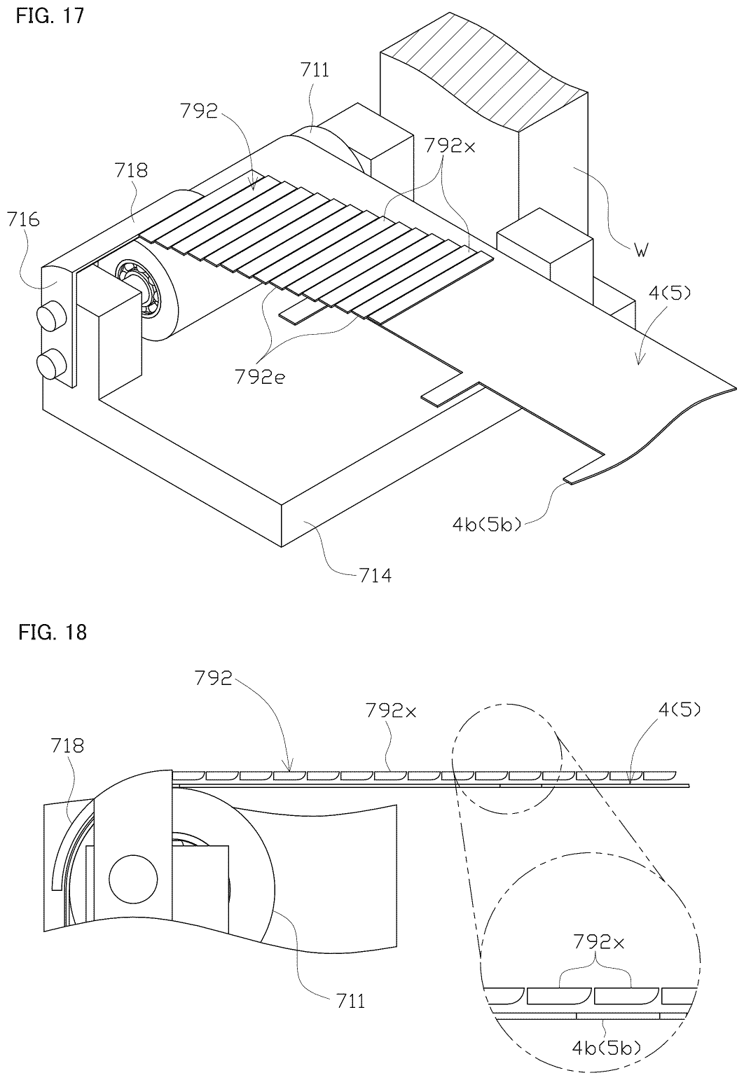

(a1) For example, as shown in FIG. 15 and FIG. 16, a metal plate or a resin plate with a width direction edge portion 791e in a curved shape or with an inlet portion 791a in a curved shaped, which is formed by bending an edge portion, may be used as a swing motion suppressing guide 791. Using the swing motion suppressing guide 791 of this configuration tends to cause a relatively small reactive force to be applied from the swing motion suppressing guide 791 to the tabs 4b or 5b when the swing-moving tabs 4b or 5b come into contact with the swing motion suppressing guide 791. Accordingly, this configuration furthermore reduces the damage possibly given to the tabs 4b or 5b.

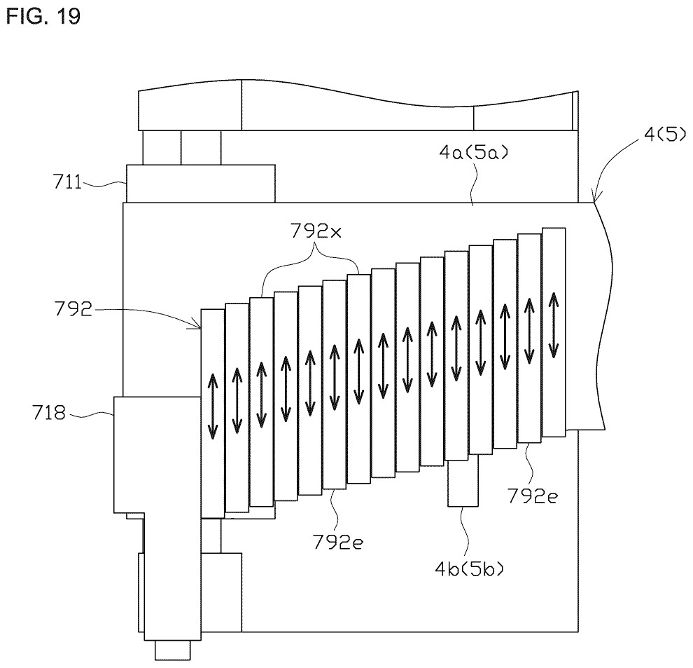

(a2-1) As shown in FIGS. 17 to 19, a swing motion suppressing guide 792 may be configured by a plurality of divisional guide portions 792x arranged along the transfer direction of the electrode sheet 4 or 5. The illustration of an upstream-side guide support portion for supporting the swing motion suppressing guide 792 is omitted in these drawings of FIGS. 17 to 19.

The divisional guide portions 792x are configured such that width direction edge portions 792e of divisional guide portions 792x located on the downstream side in the transfer direction of the electrode sheet 4 or 5 are placed on the leading end side of the tabs 4b or 5b, compared with width direction edge portions 792e of divisional guide portions 792x located on the upstream side in the transfer direction of the electrode sheet 4 or 5, when the divisional guide portions 792x are viewed from the direction perpendicular to the electrode main body 4a or 5a (i.e., along the thickness direction of the electrode main body 4a or 5a). The contact of the swing-moving tabs 4b or 5b with the width direction edge portions 792e of the divisional guide portions 792x suppresses the swing motion of the tabs 4b or 5b.

Using such divisional guide portions 792x enables the swing motion suppressing guide 792 to have a relatively simple shape. This reduces the cost related to, for example, manufacture and maintenance of the swing motion suppressing guide 792.

(a2-2) Furthermore, the divisional guide portions 792x may be configured to allow for adjustment of the respective locations along the width direction of the electrode sheet 4 or 5 (directions shown by thick line arrows in FIG. 19). This configuration enables the same swing motion suppressing guide 792 to be used for a variety of electrode sheets 4 and 5 having, for example, different shapes and different sizes by adjusting the locations of the respective divisional guide portions 792x without requiring replacement of the swing motion suppressing guide 792. This enhances the convenience in relation to production of the battery element 1 and reduces the cost related to, for example, manufacture of the apparatus.

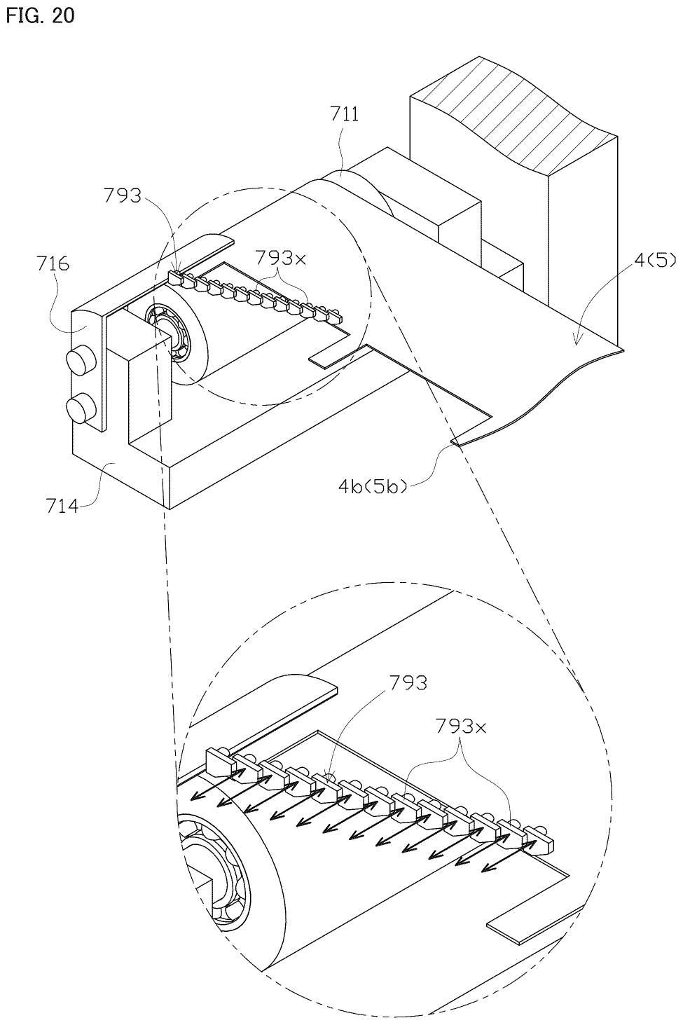

(a2-3) Additionally, as shown in FIG. 20, a swing motion suppressing guide 793 may be configured such that widths of divisional guide portions 793x are gradually decreased along a direction perpendicular to the transfer direction of the electrode sheet 4 or 5, with a view to reducing the contact area of the tabs 4b or 5b with the swing motion suppressing guide 793.

(a2-4) In terms of ensuring smooth transfer of the electrode sheet 4 or 5 (the tabs 4b or 5b) and more certainly reducing the load applied to the tabs 4b or 5b, the lengths of the divisional guide portions 792x or 793x along the transfer direction of the electrode sheet 4 or 5 may be smaller than the width of the tabs 4b or 5b, regions of the divisional guide portions 792x or 793x corresponding to the inlet for the electrode sheet 4 or 5 may be formed to have a curved surface or an inclined surface, as shown in FIG. 19 and FIG. 20.

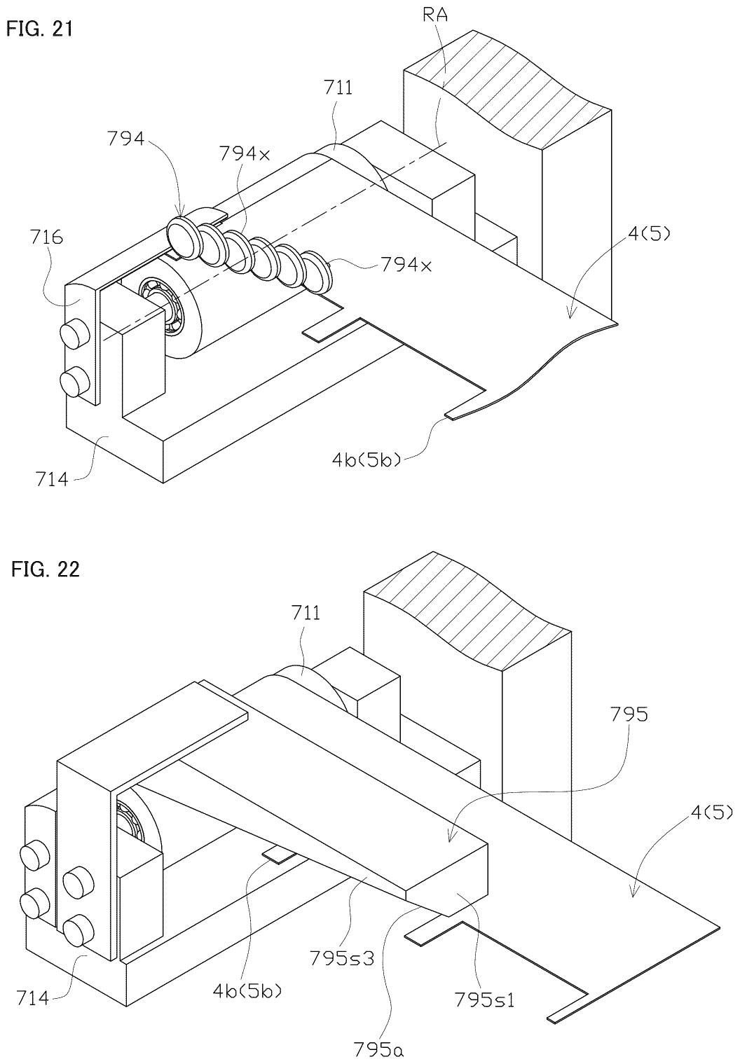

(a2-5) Moreover, as shown in FIG. 21, a divisional guide portion 794x may be configured by a roller that is freely rotatable about a rotation axis which is parallel to the rotation axis RA of the transfer roller 711. This configuration more effectively reduces the load applied to the tabs 4b or 5b when the tabs 4b or 5b are brought into contact with a swing motion suppressing guide 794 (the divisional guide portions 794x). This furthermore effectively improves the quality of the obtained battery element 1.

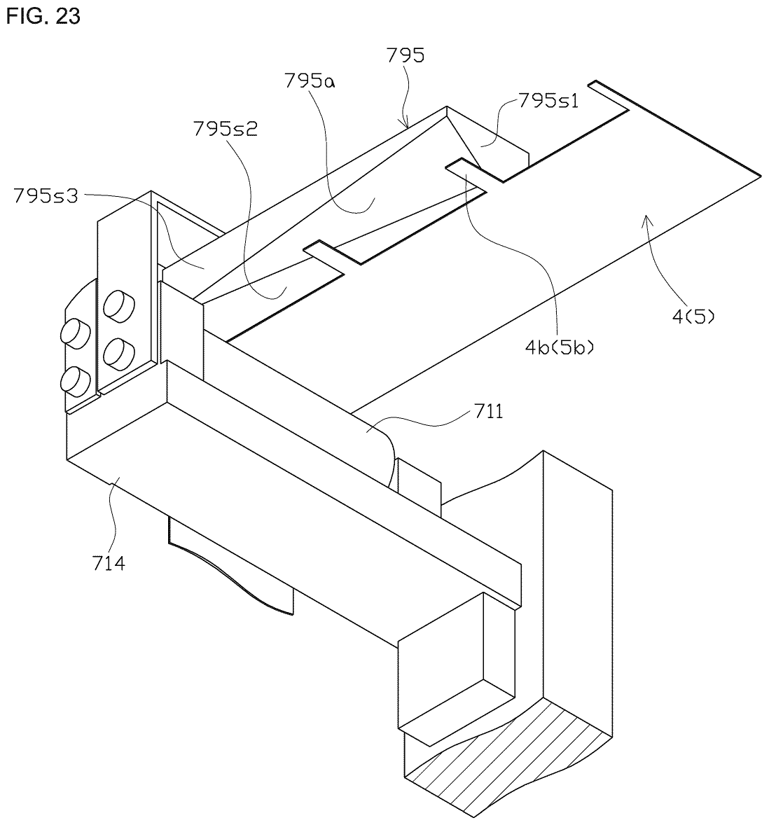

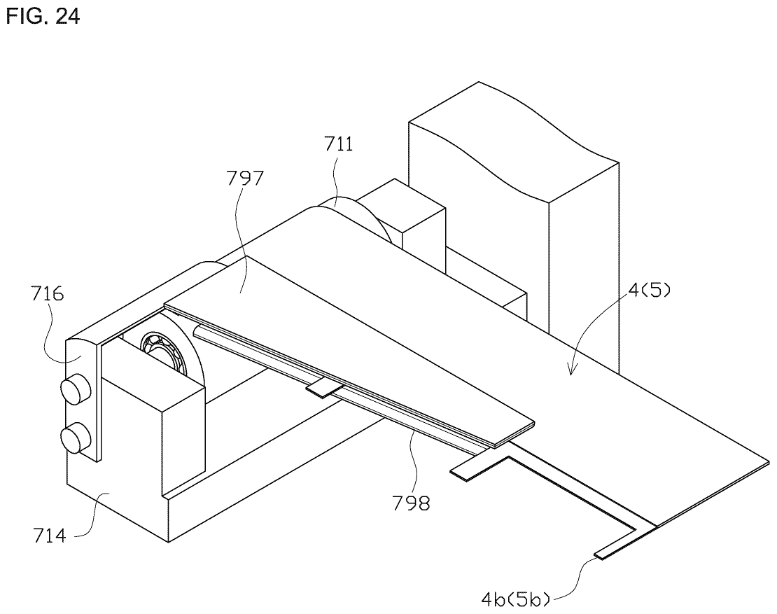

(a3) Furthermore, as shown in FIG. 22 and FIG. 23, a swing motion suppressing guide 795 may be configured to have a basic form of rectangular parallelopiped and have an inclined surface 795a. The inclined surface 795a is formed by cutting off such as to pass through an upstream side face 795s1 that is located on the upstream side in the transfer direction of the electrode sheet 4 or 5, a sheet side face 795s2 that is adjacent to the upstream side face 795sl and that faces the electrode sheet 4- or 5-side, and a tab leading end side face 795s3 that is adjacent to the upstream side face 795s1 and the sheet side face 795s2 and that is located on the leading end side of the tabs 4b or 5b. The contact of the inclined surface 795a with the swing-moving tabs 4b or 5b suppresses the swing motion of the tabs 4b or 5b.

Using this swing motion suppressing guide 795 enables the swing motion suppressing guide 795 to have a relatively simple shape. This reduces the cost related to, for example, manufacture and maintenance of the swing motion suppressing guide 795.

Moreover, the inclined surface 795a has such a shape that gradually approaches an ideal transfer path (with no swing motion) of the tabs 4b or 5b from the upstream side toward the downstream side along the transfer direction of the electrode sheet 4 or 5. The tabs 4b or 5b are thus gradually shifted to the ideal transfer path side, while the tabs 4b or 5b move with being in contact with the inclined surface 495a. Accordingly, this configuration more effectively suppresses the swing motion of the tabs 4b or 5b.

Furthermore, this configuration enables the swing motion suppressing guide 795 to have a relatively large thickness and thereby suppresses the vibration of the swing motion suppressing guide 795. This more certainly assures the effect of suppressing the swing motion of the tabs 4b or 5b.

(b) According to the embodiments described above, one swing motion suppressing guide 717 is disposed corresponding to the back side of the surface of the electrode sheet 4 or 5 that is placed on the outer circumferential face of the transfer roller 711.

According to a modification, on the other hand, one swing motion suppressing guide 717 may be disposed corresponding to the surface side of the electrode sheet 4 or 5 that is placed on the outer circumferential face of the transfer roller 711.

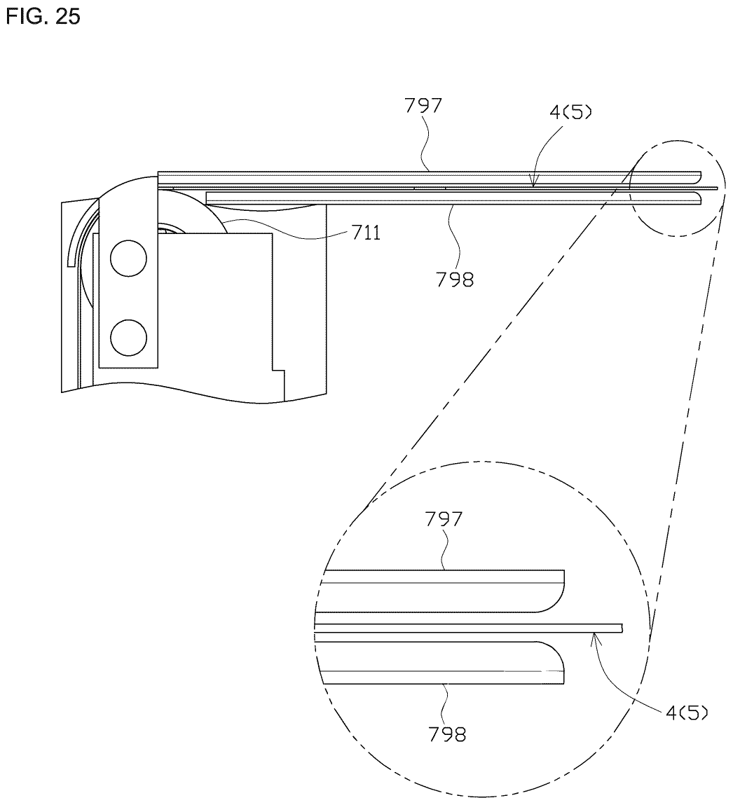

According to another modification, two swing motion suppressing guides 797 and 798 may be provided as shown in FIG. 24 and FIG. 25. One swing motion suppressing guide 797 is disposed corresponding to the back side of the surface of the electrode sheet 4 or 5 that is placed on the outer circumferential face of the transfer roller 711. The other swing motion suppressing guide 798 is disposed corresponding to the surface side of the electrode sheet 4 or 5 that is placed on the outer circumferential face of the transfer roller 711 and is also disposed at such a position that the electrode sheet 4 or 5 (the tabs 4b or 5b) is placed between one swing motion suppressing guide 797 and the other swing motion suppressing guide 798. These two swing motion suppressing guides 797 and 798 are first brought into contact with the base side of the swing-moving tabs 4b or 5b and are then brought into contact with the leading end side of the tabs 4b or 5b with the transfer of the tabs 4b or 5b, so as to gradually suppress the swing motion of the tabs 4b or 5b in the course of transfer of the electrode sheet 4 or 5 from the upstream side toward the downstream side.

Providing the two swing motion suppressing guides 797 and 798 as described above further enhances the effect of suppressing the swing motion of the tabs 4b or 5b. Each of the two swing motion suppressing guides 797 and 798 has a similar configuration to that of the swing motion suppressing guide 717 of the embodiments described above. Each of the two swing motion suppressing guides 797 and 798 may, however, have a different configuration from that of the swing motion suppressing guide 717 (for example, may have a configuration illustrated in (a) described above). According to another modification, the two swing motion suppressing guides may have different configurations from each other.

(c) According to the embodiments described above, the tabs 4b or 5b are formed by cutting part of the electrode material (i.e., formed tabs). The configuration of the tabs is, however, not limited to the embodiments. The tabs 4b or 5b may be, for example, joined with the electrode main body 4a or 5a by welding (i.e., welded tabs). The welded tabs often have relatively thick wall and are thus less likely to have swing motion. The formed tabs, on the other hand, often have relatively thin wall and are thus more likely to have swing motion. Accordingly, the winding apparatus 10 of the embodiments described above is especially effective for the electrode sheet 4 or 5 provided with the formed tabs.

(d) According to the embodiments described above, the positional relationship maintaining mechanism 72 is disposed at the position immediately upstream of the transfer roller 711 along the transfer path of the electrode sheet 4 or 5. The position where the positional relationship maintaining mechanism 72 is placed may, however, be changed appropriately. For example, the positional relationship maintaining mechanism 72 may be disposed at a position immediately downstream of the transfer roller 711 along the transfer path of the electrode sheet 4 or 5.

(e) According to the embodiments described above, the winding unit 11 is configured to include the two winding cores 13 and 14. The winding unit 11 may, however, be configured to include only one winding core or may be configured to include three or more winding cores.

Furthermore, the outer circumferential shape of the winding core is not limited to the shape described in the above embodiments. For example, the outer circumferential face of the winding core may have a circular shape or an elliptical shape in a cross section perpendicular to the rotation axis of the winding core. Moreover, the winding core may be configured without any clearance between core pieces. Additionally, the winding core may be configured to have a core component in a tubular shape that is disposed in the outer circumference of the winding core and that is configured to allow the electrode sheet 4 or 5 or the like to be wound thereon.

(f) According to the embodiments described above, the lithium-ion battery element 1 is manufactured by the winding apparatus 10. The winding element manufactured by the winding apparatus 10 is, however, not limited to this battery element 1. For example, a winding element of an electrolytic capacitor or the like may be manufactured by the winding apparatus 10.

The materials of the separator sheets 2 and 3 and of the electrode sheets 4 and 5 are not limited to those described in the above embodiments but may be changed appropriately. The active materials applied on the electrode sheets 4 and 5 may also be changed.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . lithium-ion battery element (winding element), 2, 3 . . . separator sheets, 4 . . . cathode sheet (electrode sheet), 4a, 5a . . . electrode main bodies, 4b, 5b . . . tabs, 5 . . . anode sheet (electrode sheet), 10 . . . winding apparatus, 13, 14 . . . winding cores, 711 . . . transfer roller, 717, 791, 792, 793, 794, 795, 797, 798 . . . swing motion suppressing guide, 717x . . . tapered guide plate, 718 . . . roller outer circumferential guide, 792x, 793x, 794x . . . divisional guide portions, 795a . . . inclined surface, 795s1 . . . upstream side face, 795s2 . . . sheet side face, 795s3 . . . tab leading end side face

What is claimed is:

1. A winding apparatus that winds up a belt-shaped electrode sheet including an active material and a belt-shaped separator sheet made of an insulating material, the winding apparatus comprising:
a rotatable winding core to which the electrode sheet and the separator sheet are fed at accelerating or decelerating speed, and around which the electrode sheet and the separator sheet are wound;
a rotatable transfer roller that defines a transfer path of the electrode sheet and has an outer circumference face on which the electrode sheet is placed; and
a swing motion suppressing guide disposed at a position immediately upstream of the transfer roller along the transfer path, wherein
the electrode sheet comprises:
an electrode main body on which the active material is applied; and
tabs protruded from a width direction edge portion of the electrode main body and disposed at intervals along a longitudinal direction of the electrode main body,
the swing motion suppressing guide is configured to contact the tabs and suppress a swing motion of the tabs while the electrode sheet is transferred from the upstream toward downstream of the transfer roller along the transfer path, wherein
a contact location of the tabs that contacts the swing motion suppressing guide gradually changes from a base side of the tabs to a leading end side of the tabs while the tabs move from the upstream toward the downstream.

2. The winding apparatus according to claim 1, wherein
the swing motion suppressing guide is configured by a tapered guide plate that has a width direction edge portion disposed to overlap a transfer path of the tabs,
the width direction edge portion of the tapered guide is inclined to gradually displace from a position corresponding to the base side of the tabs to a position corresponding to the leading end side of the tabs, from the upstream toward the downstream, when viewed from a direction perpendicular to the electrode main body, and
the width direction edge portion of the tapered guide is configured to contact the tabs and suppress the swing motion of the tabs.

3. The winding apparatus according to claim 1, wherein
the swing motion suppressing guide is configured by divisional guide portions disposed along the transfer path,
the divisional guide portions are configured such that width direction edge portions of divisional guide portions located on a downstream side along the transfer path are closer to the leading end side of the tabs, than are width direction edge portions of divisional guide portions located on an upstream side along the transfer path, when viewed from a direction perpendicular to the electrode main body, and
the width direction edge portions of the divisional guide portions are configured to contact the tabs and suppress the swing motion of the tabs.

4. The winding apparatus according to claim 3, wherein
a location of each of the divisional guide portions is adjustable along a width direction of the electrode sheet.

5. The winding apparatus according to claim 3, wherein
each of the divisional guide portions is configured by a roller that is freely rotatable about a rotation axis parallel to a rotation axis of the transfer roller.

6. The winding apparatus according to claim 1, wherein
the swing motion suppressing guide basically has a rectangular parallelopiped shape, and has an inclined surface formed by cutting off a part of the rectangular parallelopiped shape,
the inclined surface passes through: an upstream side face located on an upstream side along the transfer path; a sheet side face adjacent to the upstream side face and facing the electrode sheet side; and a tab leading end side face adjacent to the upstream side face and the sheet side face, and
the inclined surface is configured to contact the tabs and suppress the swing motion of the tabs.

7. The winding apparatus according to claim 1, wherein
a region of the swing motion suppressing guide corresponding to an inlet for the tabs has an inclined surface or a curved surface that gradually approaches the transfer path from the upstream toward the downstream.

8. The winding apparatus according to claim 1, wherein
a region of the swing motion suppressing guide that contacts the tabs has a curved surface without corners.

9. The winding apparatus according to claim 1, further comprising:
another swing motion suppressing guide, wherein
one of the swing motion suppressing guides is disposed corresponding to a back side of a surface of the electrode sheet, the surface contacting an outer circumferential face of the transfer roller, and
another of the swing motion suppressing guides is disposed corresponding to the surface of the electrode sheet, and is disposed at such a position that the tabs are placed between the swing motion suppressing guides.

10. The winding apparatus according to claim 1, wherein
the swing motion suppressing guide is disposed corresponding to a back side of a surface of the electrode sheet, the surface contacting an outer circumferential face of the transfer roller,
the winding apparatus further comprising:
a roller outer circumferential guide that is:
disposed adjacent to the swing motion suppressing guide along the transfer path,
disposed at such a position that the tabs are placed between the outer circumferential face of the transfer roller and the roller outer circumferential guide, and
formed to have an inner arc surface that extends along a circumferential direction of the transfer roller when viewed from a direction of a rotation axis of the transfer roller.

11. The winding apparatus according to claim 10, wherein
the roller outer circumferential guide is configured to satisfy an expression of 0.1≤R1−L1≤1.0,
where R1 millimeter denotes a radius of an inner surface of the roller outer circumferential guide about the rotation axis, and
L1 millimeter denotes a distance from the rotation axis to a width-direction edge of a leading end of the tabs, when viewed from the direction of the rotation axis, in a state where the tabs are located between the roller outer circumferential guide and the transfer roller and the leading end is flat.
